(19) United States
(12) Patent Application Publication
(10) Pub. No.: US 2008/0053550 A1
(43) Pub. Date: Mar. 6, 2008

(54) Multilayer hose construction

(75) Inventors: Richard Wayne Hatchett, Huntingdon, TN (US); John Mobley, Lexington, TN (US); Jerry Shifman, Wildersville, TN (US); Jeremy W. Duke, Lexington, TN (US)

Correspondence Address: DAYCO PRODUCTS, LLC, 1 PRESTIGE PLACE, MIAMISBURG, OH, 45342, US

(73) Assignee: Dayco Products, LLC

(21) Appl. No.: 11/513,384

(22) Filed: Aug. 30, 2006

(51) Int. Cl. F16L 11/00

(52) U.S. Cl. 138/125; 138/137; 428/36.91

(57) ABSTRACT

A tubular structure having reduced fuel permeation for use in fuel filler and fuel vent hose applications, herein the tubular structure comprises a fluoropolymer inner layer and a chloropolyethylene, chlorosulfonated polyethylene or epichlorohydrin cover layer is described. The tubular structure optionally includes a chlorinated polyethylene backing layer, one or more polyamine adhesive layers and a reinforcement layer.

### BACKGROUND OF THE INVENTION

The present invention relates to the field of multilayer hoses, and particularly to the field of flexible polymeric hoses for use in fuel feed and vapor lines.

Flexible polymeric hoses ate generally used in a variety of uses such as automobile fuel feed hoses, fuel vent hoses, torque converter hoses, power steering hoses, air conditioner hoses, brake fluid hoses, industrial hydraulic hoses and compressed gas hose, refrigerator hoses, garden hoses, propane gas hoses, etc. Various types of tubing construction have been employed to meet the needs of the various applications of hoses. For example, multilayer tubular structures are commonly used in the automotive industry as fuel feed and vapor lines. Choosing the right combination of materials used in the construction of such hoses is becoming more difficult due to environmental regulations, which severely limit the amount of fuel vapor that can permeate from the fuel system of a motor vehicle. Currently, fuel feed and vent lines are multilayer tubular structures constructed of a fluoropolymer {FKM) inner layer, a nitrile or epichlorohydrin {ECO) backing layer, a reinforcement layer, and a chlorinated polyethylene (CPE), chlorosulfonated polyethylene (CSM) or epichlorohydrin cover layer.

The overall cost and effectiveness of such hoses has proven to be somewhat disappointing. Therefore, there is a need for a fuel feed and vapor line hose which is more economical to produce and which exhibits improved properties.

### SUMMARY OF THE INVENTION

According to the present invention there is provided an improved multilayer tubular structure having a chlorinated polyethylene backing layer, which is less costly to manufacture than prior multilayer fuel transport hoses. Furthermore, chlorinated polyethylene backing layer is superior to either the nitrile or epichlorohydrin currently used as a backing layer. In addition to reduced permeability, the hose has adequate strength and durability over long periods of time.

Since it is well known in the industry that hoses used to transport fuels are required to contain a conductive agent or otherwise exhibit conductive characteristics in order to dissipate any electrical buildup, which may occur during the flow of fuel through the hose, the hose of the present application may contain such conductive agent.

In a first embodiment, the fuel feed and vapor line hose of the present invention comprises: a fluoropolymer (FKM) inner layer, an adhesive layer, a chlorinated polyethylene (CPE) backing layer, a reinforcement layer, and a chlorinated polyethylene, chlorosulfonated polyethylene (CSM) or epichlorohydrin (ECO) cover layer.

In a second embodiment, the fuel feed and vapor line hose of the present invention comprises: a fluoropolymer (FKM) inner layer, and a chlorinated polyethylene, chlorosulfonated polyethylene (CSM), or epichlorohydrin (ECO) cover layer.

In those instances where the tetrafluoroethylene-hexafluoropropylene-vinylidene fluoride (THV) is adjacent the chlorinated polyethylene layer, a polyamine adhesive is preferably used to adhere the CPE layer to the THV layer.

Typically, the hoses of the present invention are useful as automobile fuel vent hoses, fuel filler hose, vapor lines and fuel feed lines.

### BRIEF DESCRIPTION OF THE DRAWINGS

FIG. 1 is a perspective view illustrating a first embodiment of the invention;

FIG. 2 is a perspective view illustrating a second embodiment of the invention; 2

### DETAILED DESCRIPTION OF THE INVENTION

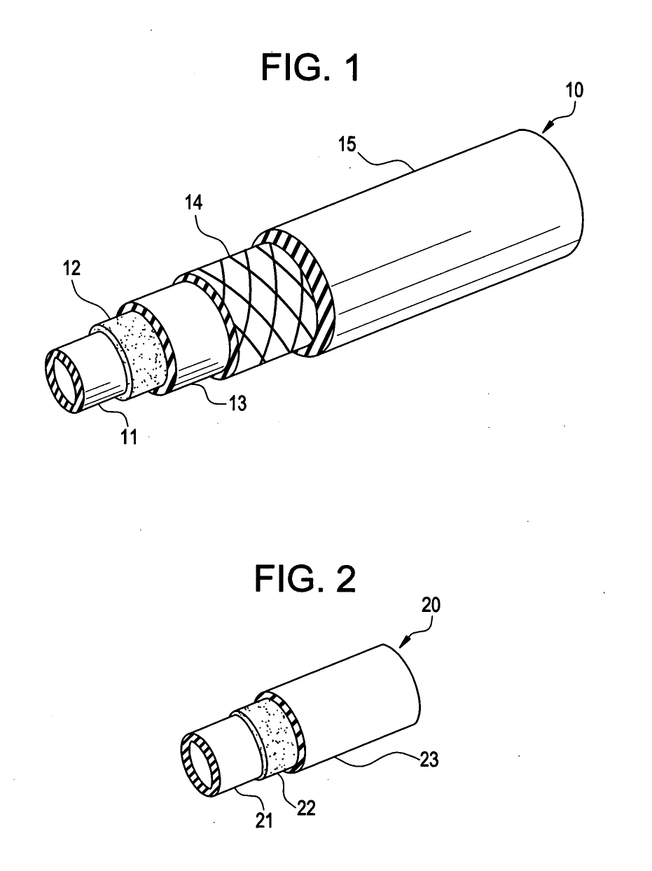

With respect to the drawings, FIG. 1 is a tubular structure in accordance with a first embodiment of the invention where a tubular structure 10 is made from a fluoropolymer (FKM) 11, an adhesive layer 12 surrounding the outer surface of the fluoropolymer 11, a chlorinated polyethylene backing layer 13 on top of the adhesive layer 12, a reinforcement layer 14 surrounding the chlorinated polyethylene backing layer 13, and a chlorinated polyethylene, chlorosulfonated polyethylene, or epichlorohydrin cover 15 surrounding the reinforcement layer 14 and forming the outside layer of the tubular structure 10.

FIG. 2 is a tubular structure in accordance with a second embodiment of the invention where a tubular structure 20 is made from a fluoropolymer (FKM) inner layer 21, an adhesive layer 22 surrounding the outer surface of the fluoropolymer (FKM) inner layer 21, and a chlorinated polyethylene, chlorosulfonated polyethylene, or epichlorohydrin cover 23 surrounding the adhesive layer 22 and forming the outside layer of the tubular structure 20.

Typically, the backing layer of the tubular structure is a nitrile material such as acrylonitrile-butadiene polymer or an epichlorohydrin (ECO) material. It has been found that, in the manufacture of a fuel feed or vapor line hose, chlorinated polyethylene provides an improved and more cost efficient alternative to the nitrile or epichlorohydrin as the backing layer.

The fluoropolymer (FKM) inner layer of the tubular structure prevents or reduces the permeation of fuel and vapor through the inner layer. Preferably, the fluoropolymer (FKM) inner layer is ______

### PLEASE PROVIDE OTHER FLUOROPOLYMERS THAT CAN BE USED IN PLACE OF FKM

The reinforcement materials useful in the present invention include natural and synthetic fibers such as rayon, polyesters, aramids, and polyamides, e.g., nylon, polyimides, polyvinyl acetate, metal wire, any other suitable materials known in the art to provide reinforcement in hoses.

Typically, the inner layer of the tubular structure contains a conductive material such as metal or carbon. Preferably, the conductive material is carbon in the form of carbon black, but may be any conductive agent or combination of conducting agents commonly recognized in the industry to provide conductivity to a rubber or plastic material. Examples of such conductive agents include elemental carbon in the form of carbon black and carbon fibrils, metals such as copper, silver, gold, nickel; and alloys and mixtures of such metals. The use of such conductive agents is known in the art to dissipate static electricity in the transportation of a fluid through the tubular structure.

It is generally preferred to include an adhesive material between the chlorinated polyethylene layers and the fluoropolymer layers in order to prevent or reduce the likelihood of the two layers separating during use.

Other additives such as antioxidants, processing aids, etc. may be employed in amounts and methods known in the art.

The tubular structures of the present invention are formed by extruding the various layers using simultaneous or tandem extrusion.

Having described the invention in detail and by reference to preferred embodiments thereof, it will be apparent to those skilled in the art that modifications and variations are possible without departing from the scope of the invention defined in the appended claims.

What is claimed is:

1. A tubular structure having reduced fuel permeation for use as fuel feed and vapor line hose applications, wherein said tubular structure comprises a fluoropolymer inner layer and a chlorinated polyethylene, chlorosulfonated, or epichlorohydrin cover layer.

2. The tubular structure of claim 1, wherein said cover layer is a chlorinated polyethylene cover layer.

3. The tubular structure of claim 1, further comprising a chlorinated polyethylene backing layer between said fluoropolymer inner layer and said chlorinated polyethylene, chlorosulfonated polyethylene, or epichlorohydrin cover layer.

4. The tubular structure of claim 3, wherein said cover layer is a chlorinated polyethylene cover layer.

5. The tubular structure of claim 1 further comprising a reinforcement layer between said chlorinated polyethylene backing layer and said chlorinated polyethylene, chlorosulfonated polyethylene, or epichlorohydrin cover layer.

6. The tubular structure of claim 2 further comprising a polyamine adhesive layer between said fluoropolymer inner layer and said chlorinated polyethylene cover layer.

7. The tubular structure of claim 6 wherein said polyamine adhesive layer is a polyallylamine adhesive layer.

8. The tubular structure of claim 1 wherein said fluoropolymer inner layer includes a conductive material therein selected from the group consisting of carbon, iron, silver, gold, copper, nickel, and alloys and mixtures thereof.

9. The tubular structure of claim 8 wherein said conductive material is carbon.

10. The tubular structure of claim 8 wherein said conductive material is carbon.

11. The tubular structure of claim 9 wherein said carbon conductive material is in the form of carbon powder or carbon fibrils.

12. A tubular structure having reduced fuel permeation for use as fuel feed and vapor line hose applications, said tubular structure comprising a fluoropolymer inner layer, a polyamine adhesive surrounding said fluoropolymer inner layer, a chlorinated polyethylene layer surrounding said polyamine adhesive layer, a reinforcement layer surrounding said chlorinated polyethylene layer, and a chlorinated polyethylene layer surrounding said reinforcement layer and forming an outer cover around said tubular structure.

13. The tubular structure of claim 12 wherein said polyamine adhesive agent is polyallylamine.

14. The tubular structure of claim 13 wherein said fluoropolymer includes a conductive agent selected from the group consisting of carbon, iron, silver, gold, nickel, copper, and alloys thereof.

15. The tubular structure of claim 14, wherein said conductive agent is carbon.

16. The tubular structure of claim 15, wherein said carbon is in the form of carbon powder or carbon fibrils.

17. A tubular structure having reduced fuel permeation for use in fuel feed and vapor line hose applications, said tubular structure comprising a fluoropolymer inner layer, a polyamine adhesive layer surrounding said fluoropolymer inner layer, and a chlorinated polyethylene layer surrounding said polyamine adhesive layer.

18. The tubular structure of claim 17, wherein said polyamine adhesive agent is a polyallylamine.

19. The tubular structure of claim 17, wherein said fluoropolymer includes a conductive agent selected from the group consisting of carbon, iron, silver, gold, nickel, copper, and alloys and mixtures thereof.

20. The tubular structure of claim 19, wherein said conductive agent is carbon.

21. The tubular structure of claims 20, wherein said carbon is in the form of carbon powder or carbon fibrils.

22. A method of manufacturing a tubular structure, said method comprising:
forming a first layer of a fluoropolymer; and
forming a cover layer around said first layer of said fluoropolymer.

23. The method of claim 22, wherein said fluoropolymer is an FKM fluoropolymer.

24. The method of claim 22, wherein said cover layer is selected from the group consisting of chlorinated polyethylene, chlorosulfonated polyethylene, and epichlorohydrin.

25. The method of claim 22 further comprising a chlorinated polyethylene backing layer between said fluoropolymer inner layer and said cover layer.

26. The method of claim 25 further comprising a reinforcement layer between said chlorinated polyethylene backing layer and said cover layer.

27. The method of claim 26 further comprising an adhesive layer between at least one of said chlorinated polyethylene backing layer and said reinforcement layer, and said reinforcement layer and said cover layer.

28. The method of claim 27, wherein said adhesive layer is a polyamine adhesive layer.

29. The method of claim 28 wherein said polyamine adhesive layer is polyallylamine adhesive layer.

30. The method of claim 22, wherein said fluoropolymer inner layer includes a conductive material selected from the group consisting of carbon, iron, silver, gold, copper, nickel, and alloys thereof.

31. The method of claim 30, wherein said conductive material is carbon.

32. The method of claim 31, wherein said carbon conductive material is in the form of carbon powder or carbon fibrils.
